(19) United States
(12) Patent Application Publication
(10) Pub. No.: US 2021/0102656 A1
(43) Pub. Date: Apr. 8, 2021

(54) GIMBAL

(71) Applicant: SZ DJI TECHNOLOGY CO., LTD., Shenzhen (CN)

(72) Inventors: Sicong LIU, Shenzhen (CN); Tao ZHAO, Shenzhen (CN); Shanguang GUO, Shenzhen (CN); Yong LIU, Shenzhen (CN)

(21) Appl. No.: 17/125,444

(22) Filed: Dec. 17, 2020

Related U.S. Application Data
(63) Continuation of application No. PCT/CN2018/095151, filed on Jul. 10, 2018.

(51) Int. Cl. F16M 11/10; F16M 11/18; F16M 11/20; G03B 17/56

(52) U.S. Cl. CPC F16M 11/105; F16M 11/18; F16M 11/2014; F16M 13/04; G03B 17/561; F16M 2200/024; F16M 11/2071

(57) ABSTRACT

A gimbal includes a rotation assembly. The rotation assembly includes an axis arm, a lock device, and an electric motor configured to drive the axis arm with a first driving force to rotate to a pre-set position, such that the lock device locks the axis arm at the pre-set position, and when the axis arm is at the pre-set position, drive the axis arm with a second driving force to rotate, such that the lock device unlocks the axis arm.

### CROSS-REFERENCE TO RELATED APPLICATION

This application is a continuation of International Application No. PCT/CN2018/095151, filed on Jul. 10, 2018, the entire content of which is incorporated herein by reference.

### TECHNICAL FIELD

The present disclosure relates to the technical field of stabilization devices and, more particularly, to a gimbal.

### BACKGROUND

In the related art, a locking mechanism is provided at a gimbal. The locking mechanism is used to lock a rotation shaft of the gimbal to prevent the rotation shaft from rotating freely. However, a locking force of the locking mechanism may be too strong, resulting in inconvenience when the gimbal is being locked and unlocked.

### SUMMARY

In accordance with the disclosure, there is provided a gimbal including a rotation assembly. The rotation assembly includes an axis arm, a lock device, and an electric motor configured to drive the axis arm with a first driving force to rotate to a pre-set position, such that the lock device locks the axis arm at the pre-set position, and when the axis arm is at the pre-set position, drive the axis arm with a second driving force to rotate, such that the lock device unlocks the axis arm.

Also in accordance with the disclosure, there is provided another gimbal including a rotation assembly. The rotation assembly includes a first axis arm configured to rotate around a rotation axis, a second axis arm rotatably connected to the first axis arm and rotatably disposed at an external device, such that the gimbal as a whole rotates relative to the external device, and a lock device including a first element and a second element configured to be attracted to each other to lock the first axis arm relative to the second axis arm. When the first axis arm is locked, the first axis arm is fixed relative to the second axis arm.

### BRIEF DESCRIPTION OF THE DRAWINGS

FIG. 1 is a schematic perspective view of a gimbal according to an example embodiment of the present disclosure.

FIG. 2 is a perspective view of a part of a gimbal according to an example embodiment of the present disclosure.

FIG. 3 is a schematic diagram showing an internal structure of a gimbal according to an example embodiment of the present disclosure.

FIG. 4 and FIG. 5 are schematic diagrams showing statuses of a gimbal according to an example embodiment of the present disclosure.

FIG. 6 and FIG. 7 are schematic perspective views of a gimbal according to another example embodiment of the present disclosure.

FIG. 8 and FIG. 9 are schematic views of a gimbal according to another example embodiment of the present disclosure.

### REFERENCE NUMERALS IN THE DRAWINGS

200: gimbal
100: rotation assembly
102: rotation axis
10: first axis arm
20: electric motor
21: rotation shaft
211: shaft end surface
30: lock device
31: elastic member
32: first limiting structure
321: snap recess
322: guide surface
33: second limiting structure
331: snap protrusion
34: first magnetic member
35: second magnetic member
40: second axis arm
50: electric motor base
51: outer wall
60: display device
300: load

### DETAILED DESCRIPTION OF THE EMBODIMENTS

Embodiments of the present disclosure are described in detail below with reference to the accompanying drawings. Same or similar reference numerals represent the same or similar elements or elements with the same or similar functions. The described embodiments are some rather than all of the embodiments of the present disclosure. Other embodiments obtained by those having ordinary skills in the art on the basis of the described embodiments without inventive efforts should fall within the scope of the present disclosure.

It should be understood that, in the description of the present disclosure, directional or positional relationships indicated by terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” are based on directional or positional relationships shown in the accompanying drawings. They are intended only for the convenience of describing the application and simplifying the description, and do not indicate or imply that the referred device or element must have the particular orientation, or be constructed and operated in the particular orientation. Hence, they should not be construed as restrictions on the present disclosure. In addition, terms such as “first,” “second” are only used for descriptive purposes, and should not be construed as indicating or implying relative importance or implicitly indicating a number of referred technical features. Thus, features defined with “first” and “second” may explicitly or implicitly include one or more of the referred features. In the description of the present disclosure, “plurality” refers to two or more unless otherwise specifically defined.

It should be understood that, in the description of the present disclosure, unless otherwise clearly defined and limited, terms such as “install,” “link,” “connect” should construed in a broad sense. For example, the terms may refer to a fixed connection, a detachable connection, or an integral connection. The terms may also refer to a mechanical connection, an electrical connection, or communication with each other. The terms may also refer to a direction connection, an indirection connection through an intermediate structure, an internal connection between two members, or a mutual interaction relationship between two members. For those of ordinary skill in the art, the specific meanings of the above terms in the specification of the present disclosure may be understood according to specific circumstances.

In the present disclosure, unless otherwise defined and limited, a first feature being “above” or “below” a second feature first may include a direct contact between the first feature and the second feature, or may include no direct contact between the first feature and the second feature but through other features being between them. Moreover, the first feature being “above,” “over,” and “on” the second feature may include the first feature directly above and obliquely above the second feature or simply refer to the first feature being at a higher level than the second feature. The first feature being “below,” “under,” and “beneath” the second feature may include the first feature being directly below or obliquely below the second feature or simply refer to the first feature being at a lower level than the second feature.

The present disclosure provides various different embodiments or examples for implementing various structures of the present disclosure. To simplify the specification of the present disclosure, structures and configurations of specific examples are described below. The embodiments are only some examples of the present disclosure and are not intended to limit the present disclosure. In addition, reference numerals and/or reference alphabets may be repeated in various examples of the present disclosure. Such repetitions are for the purposes of brevity and clarity, and do not indicate relationships between various embodiments and/or configurations. Further, the present disclosure also provides examples of various processes and materials. However, those of ordinary skill in the art may be aware of applications of other processes and/or use of other materials.

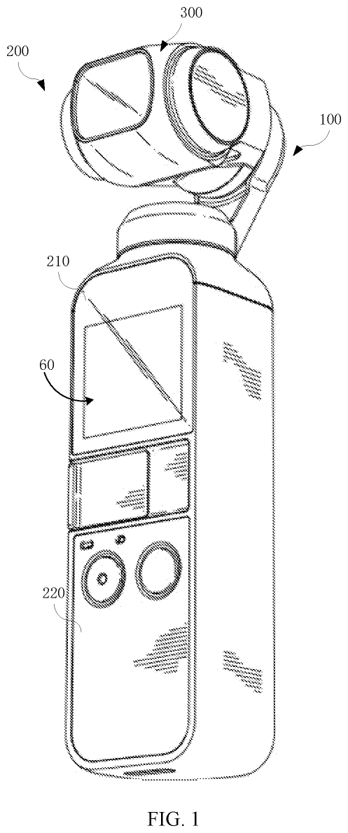

Referring to FIG. 1 through FIG. 3, in one embodiment, the gimbal 200 includes at least one rotation assembly 100. Each rotation assembly 100 includes a first axis arm 10, an electric motor 20, and a lock device 30.

The electric motor 20 drives the first axis arm 10 to rotate. After the electric motor 20 drives the rotation assembly 100 with a first driving force to rotate to a pre-set position, the lock device 30 locks the rotation assembly 100. At the pre-set position, the electric motor 20 drives the rotation assembly 100 with a second driving force to rotate, such that the lock device 30 unlocks the rotation assembly 100.

In some embodiments, the electric motor 20 of the gimbal 200 drives the rotation assembly 100 to rotate, such that the lock device 30 is able to lock and unlock the rotation assembly 100. Directly locking and unlocking the rotation assembly 100 with the first driving force and the second driving force respectively simplifies locking and unlocking processes and operations. In addition, the processes of locking and unlocking the rotation assembly 100 are performed without manually driving the rotation assembly 100, thereby improving the user experience.

Specifically, there can be one, two, or three rotation assemblies 100. A load such as a camera can be mounted at the first axis arm 10 and hence stabilization of the load 300 can be realized.

The electric motor 20 may be a servo motor or a step motor. The electric motor 20 may drive the first axis arm 10 to rotate to achieve the stabilization of the load 300. The lock device 30 may include a mechanical lock structure. The mechanical lock structure of the lock device 30 may generate a locking force for locking the rotation assembly 100 by via contacting between two components. The lock device 30 may include another suitable lock structure using an attraction force or a repulsion force, such as attracting or repelling magnets, a hydraulic or pneumatic structure, or another suitable lock structure, which is not limited by the present disclosure.

For example, after the gimbal 200 receives a power-down command, the gimbal 200 may control the electric motor 20 to drive the rotation assembly 100 with the first driving force to rotate to the pre-set position, such that the rotation assembly 100 is locked in a locked state. As such, when the gimbal 200 moves freely in a non-operation state, the rotation assembly 100 is prevented from being damaged by physical impacts. In some embodiments, the electric motor 20 of the gimbal 200 is powered off, and the gimbal 200 is in the non-operation state. After the assembly 100 is locked, the gimbal 200 does not move freely in the non-operation state, thereby preventing the damages caused by physical impacts.

In another example, after the gimbal 200 receives a power-on command, the gimbal 200 may control the electric motor 20 to drive the rotation assembly 100 with the second driving force to unlock the rotation assembly 100 into an unlocked state. Thus, the rotation assembly 100 is able to rotate to achieve the stabilization of the load 300.

In some embodiments, output values of the first driving force and the second driving force are greater than an output value outputted by the electric motor 20 when the gimbal 200 is in an operation state. The operation state of the gimbal 200 refers to a state in which the gimbal 200 is powered on and the electric motor 20 can adjust the rotation assembly 100 of the gimbal 200. As such, the electric motor 20 drives the lock device 30 with a greater driving force to lock and unlock the rotation assembly 100, such that accidental locking is avoided when the gimbal 200 is in the operation state.

Further, in some embodiments, the first driving force and the second driving force are pre-configured. In other words, the first driving force and the second driving force may be configured as needed. The first driving force may be greater than, equal to, or smaller than the second driving force, which is not limited by the present disclosure. In one embodiment, the first driving force and the second driving force are pre-configured to equal each other.

In some embodiments, the first driving force and the second driving force are configured according to externally inputted commands. For example, the gimbal 200 may include an input device such as buttons and touch devices. Before the rotation assembly 100 is locked or unlocked, the first driving force or the second driving force may be inputted through the input device, such that the input device generates a corresponding command to control the electric motor 20 to rotate with the corresponding driving force to enter the locked state or the unlocked state.

Further, referring to FIG. 1, in some embodiments, the gimbal 200 also includes a display device 60. The numerical values of the first driving force and the second driving force may be displayed on the display device 60. As such, the display device 60 displays the strength of the first driving force and the second driving force. Further, the display device 60 may be connected to the input device equipped with the buttons and the touch device, such that a user inputs the strength of the first driving force and the second driving force according to the user's need or preference. Thus, the electric motor 20 may be controlled to drive the rotation assembly 100 to rotate with the corresponding driving force.

In one example, the display device 60 includes a screen display device such as a liquid crystal display (LCD) screen or an OLED display screen. In another example, the display device 60 may display specific information such as 20N first driving force and 25N second driving force.

In some embodiments, the gimbal 200 also includes a base 210 and a handle 220. The display device 60 may be disposed at the base 210 or the handle 220 to facilitate the user to input or retrieve data. It should be understood that the display device 60 may be disposed at the first axis arm 10 or may be disposed separated from the first axis arm 10. Thus, the specific position of the display device 60 is not limited by the present disclosure.

Referring to FIG. 1 through FIG. 3, in some embodiments, the rotation assembly 100 also includes a second axis arm 40, rotatably connected to the first axis arm 10. The electric motor 20 drives the first axis arm 10 to rotate around a rotation axis 102 relative to the second axis arm 40. After the electric motor 20 drives the first axis arm 10 with the first driving force to rotate to the pre-set position, the first axis arm 10 is locked with the second axis arm 40 through the lock device 30. At the pre-set position, the electric motor 20 drives the first axis arm 10 with the second driving force to rotate, such that the lock device 30 releases the locking between the second axis arm 40 and the first axis arm 10.

Therefore, the rotation assembly 100 includes two axis arms to facilitate the mounting of the first axis arm 10 on the second axis arm 40. When the first axis arm 10 is in the locked state, the first axis arm is fixed relative to the second axis arm 40.

In some embodiments, the second axis arm 40 may be rotatably disposed at an external device such as an unmanned aerial vehicle (UAV) or a handheld tripod. For example, the second axis arm 40 may be rotatably disposed at the handheld tripod, such that the entire gimbal 200 rotates relative to the handheld tripod. In another example, the second axis arm 40 may rotate around a yaw axis relative to the external device.

In some embodiments, the rotation axis 102 is a roll axis. In other words, the electric motor 20 drives the first axis arm 10 to rotate around the roll axis relative to the second axis arm 40. In some embodiments, the rotation axis 102 may also be another axis such as the yaw axis.

In some embodiments, the second axis arm 40 may be omitted. In other words, the rotation assembly 100 can include one single axis arm (the first axis arm). In some other embodiments, the number of axis arms in the rotation assembly 100 may be three or more, which is not limited by the present disclosure.

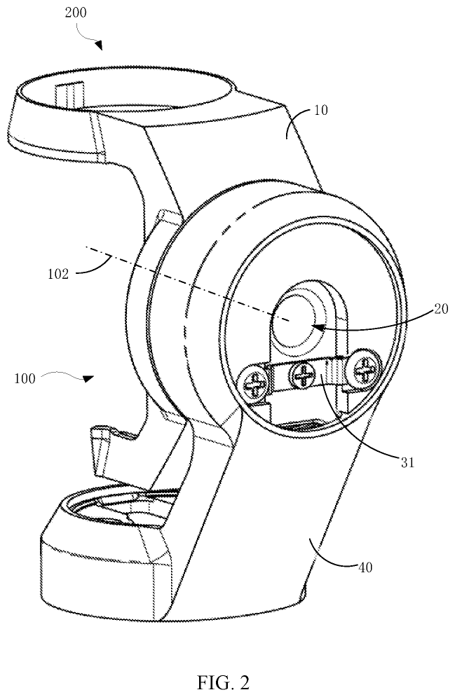

Referring to FIG. 2, the first axis arm 10 has a bifurcated shape, and the middle part of the first axis arm 10 is rotatably connected to the second axis arm 40. It should be noted that specific shapes of the first axis arm 10 and the second axis arm 40 may be designed as needed, and are not limited to the examples in the drawings.

In some embodiments, the first axis arm 10 is provided with a pre-set operational angle range, and the pre-set position for locking and unlocking the rotation assembly 100 is located outside the operational angle range of the first axis arm 10. For example, in one embodiment, when the first axis arm is in operation, the first axis arm 10 rotates within a range between −45° and 45° relative to the second axis arm 40. In this case, the pre-set position may be located at a position outside the operational range of the first axis arm 10 after the first axis arm 10 rotates to −60° or 60°, such that the gimbal 200 stably rotates within the pre-set operational angle range.

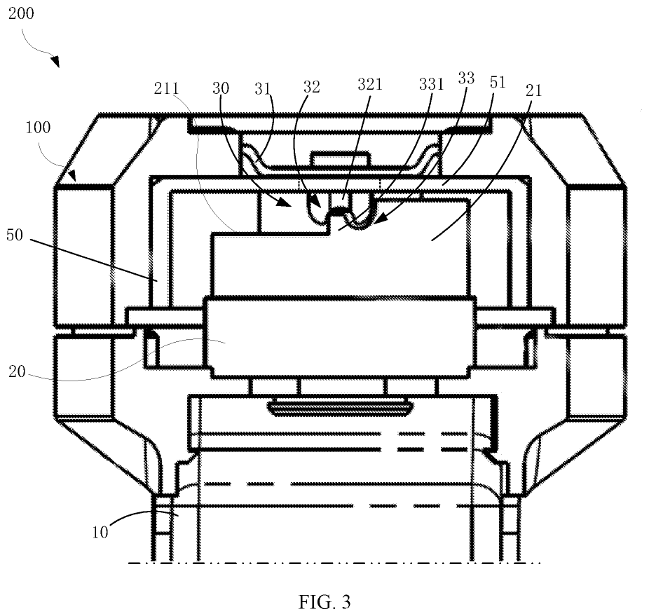

Referring to FIG. 3, in some embodiments, the lock device 30 includes an elastic member 31 fixed to an electric motor base 50. The elastic member 31 is provided with a first limiting structure 32 along an axial direction of the electric motor 20. The lock device 30 also includes a second limiting structure 33 disposed at a rotation shaft 21 of the electric motor 20. After the electric motor 20 drives the rotation assembly 100 to rotate to the pre-set position, the first limiting structure 32 is engaged with the second limiting structure 33 to prevent the rotation assembly 100 from rotating, thereby locking the rotation assembly 100.

In this way, the lock device 30 locks the rotation assembly 100 in a snap-fit manner, which has a simple structure and is easy to implement. Specifically, the electric motor base 50 is used to mount the electric motor 20. The elastic member 31 may be fixed to the electric motor 50 by welding, fastener connection, or the like.

Further, the elastic member 31 includes an elastic piece or a spring. When the elastic member 31 is the elastic piece, the elastic piece may be made of an elastic metallic material such as stainless steel. The elastic force of the elastic member 31 may be set according to the thickness of the elastic piece. When the elastic member 31 is the spring, the spring may be a coil spring. In this case, the elastic force of the elastic member 31 may be set according to the elastic stiffness of the spring. In some embodiments, the elastic member 31 may be another elastic element.

The second limiting structure 33 and the rotation shaft 21 of the electric motor 20 may be an integral structure or may be separate structures. When the second limiting structure 33 and the rotation shaft 21 of the electric motor 20 are separate structures, the second limiting structure 33 may be fixed to the rotation shaft 21 of the electric motor 20 by welding or the like.

In some embodiments, the second limiting structure 33 is provided at a shaft end surface 211 of the rotation shaft 21 of the electric motor 20. The elastic member 31 is disposed opposite to the shaft end surface 211. As such, the fixing position of the second limiting structure 33 is easy to be provided, and the gimbal 200 is easy to manufacture and form.

Referring to FIG. 3, in some embodiments, the first limiting structure 32 is formed with a snap recess 321. The second limiting structure 33 is formed with a snap protrusion 331 coupled with the snap recess 321. The snap protrusion 331 rotates with the rotation shaft 21 of the electric motor 20. When the snap protrusion 331 reaches the snap recess 321, the elastic member 31 deforms in a direction facing away from the snap protrusion 331 and then resets, such that the snap protrusion 331 snaps into the snap recess 321 when the rotation assembly 100 rotates to the pre-set position.

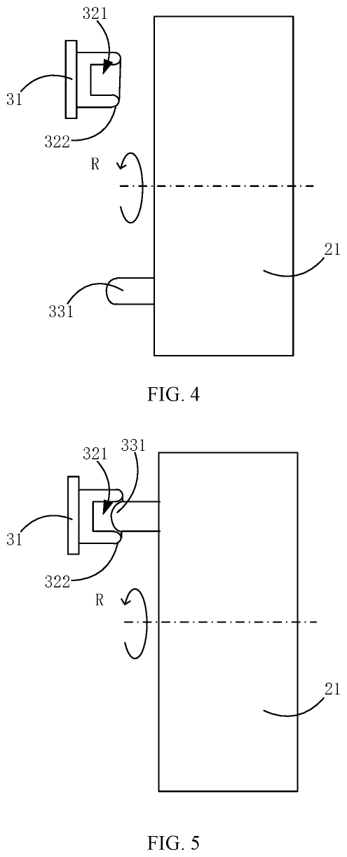

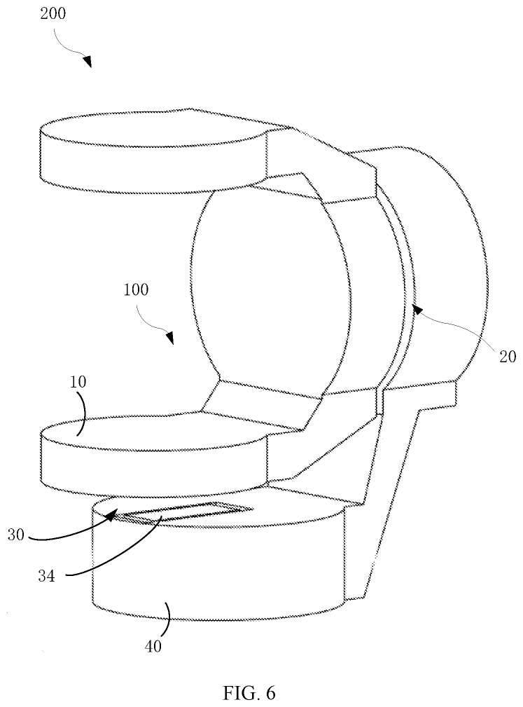

In this way, after the snap protrusion 331 snaps into the snap recess 321, the rotation assembly 100 is prevented from rotating, thereby locking the rotation assembly 100. Specifically, referring to FIG. 4 and FIG. 5, when the rotation assembly 100 is not locked, the snap protrusion 331 is located, for example, at a position shown in FIG. 4. After the rotation shaft 21 of the electric motor 20 rotates in the direction R, the snap protrusion 331 rotates along with the rotation shaft 21, and eventually snaps into the snap recess 321, as shown in FIG. 5.

At this time, the rotation shaft 21 of the electric motor 20 stops rotating, and hence the rotation assembly 100 is locked.

After the snap protrusion 331 snaps into the snap recess 321, when the electric motor 20 drives the rotation shaft 21 to rotate with a force stronger than the elastic force of the elastic member 31, the snap protrusion 331 escapes from the snap recess 321. At the same time, the rotation assembly is unlocked, and the electric motor 20 may drive the rotation assembly 100 to rotate. It should be noted that, as shown in FIG. 2 and FIG. 3, the first axis arm 10 is connected to the electric motor 20. Thus, when the electric motor 20 rotates, the first axis arm 10 and the first limiting structure 32 rotate with the electric motor 20.

In other embodiments, the first limiting structure 32 is formed with the snap protrusion and the second limiting structure is formed with the snap recess coupled with the snap protrusion. The snap recess rotates with the rotation shaft 21 of the electric motor 20. When the snap protrusion reaches the snap recess, the elastic member 31 deforms in the direction facing away from the snap protrusion and then resets, such that the snap protrusion snaps into the snap recess when the rotation assembly 100 rotates to the pre-set position.

Referring to FIG. 3, in some embodiments, the electric motor base 50 includes an outer wall 51. The elastic member 31 is disposed outside the outer wall 51. The first limiting structure 32 passes through the outer wall 51 in the axial direction of the electric motor 20 and enters the inside of the outer wall 51. During the elastic deformation of the elastic member 31, the first limiting structure 32 moves relative to the outer wall 51 along the axial direction of the electric motor 20.

Disposing the elastic member 31 outside the outer wall 51 facilitates the mounting of the elastic member 31 and avoids interference between the elastic member 31 and the electric motor 20. In addition, having the first limiting structure 32 pass through the outer wall 51 to enter the inside of the outer wall 51 makes it easier for the first limiting structure 32 and the second limiting structure 33 to engage with each other to lock the rotation assembly 100.

Further, in one embodiment, the first limiting structure 32 has a columnar shape. For example, the first limiting structure 32 may have a cylindrical shape or a square column shape. It should be understood that an axial dimension of the first limiting structure 32 is greater than a thickness of the outer wall 51, such that the first limiting structure 32 is able to engage with the second limiting structure 33 when moving relative to the outer wall 51.

As shown in FIG. 4 and FIG. 5, in some embodiments, the first limiting structure 32 is formed with a guide surface 322 for guiding the snap protrusion 331 to snap into the snap recess 321. In this way, the guide surface 322 guides the snap protrusion 331 to smoothly snap into the snap recess 321. For example, the guide surface 322 may be an arc-shaped surface or an inclined surface, which guides the snap protrusion 331 to snap into the snap recess 321.

In some embodiments, the lock device 30 includes a first element fixed to the first axis arm 10 and a second member fixed to the second axis arm 40. When the second axis arm 40 is located at the pre-set position, the first element and the second element are attracted or repelled to lock the first axis arm 10 and the second axis arm 40.

In this way, the first element and the second element lock the first axis arm 10 and the second axis arm 40 by a force of attraction or repulsion. For example, the first element and the second element may be hydraulic elements, pneumatic elements, or magnetic members that generate attractive or repulsive forces.

In some embodiments, the first element is for example a first magnetic member 34 and the second element is for example a second magnetic member 35, which will be described in detail below.

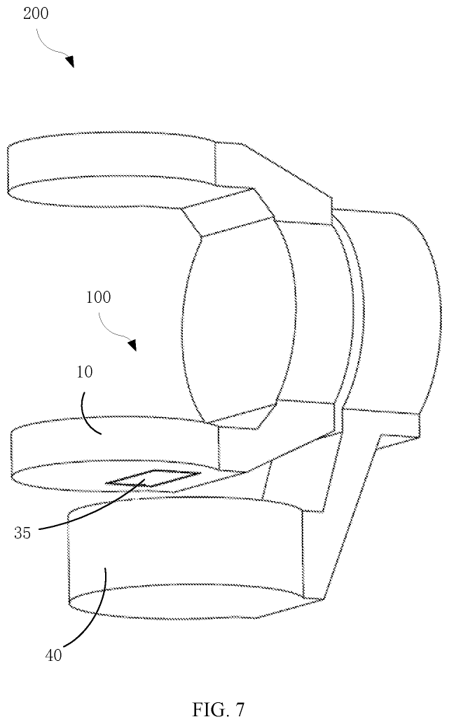

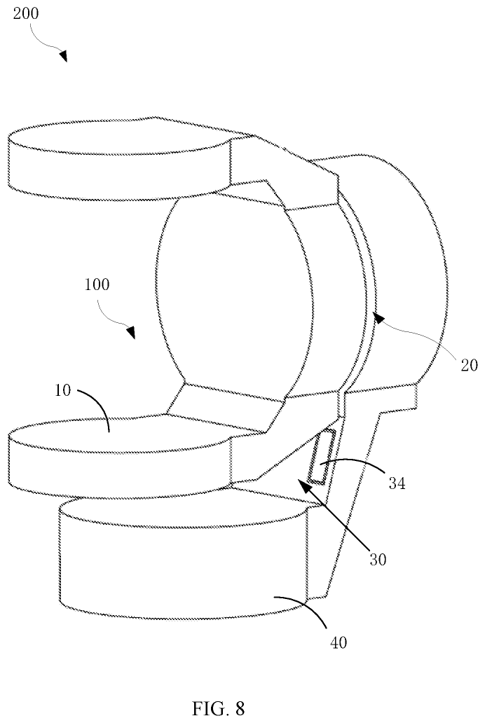

Referring to FIG. 6 and FIG. 7, in some embodiments, the lock device 30 includes the first magnetic member 34 fixed to the first axis arm 10 and the second magnetic member 35 fixed to the second axis arm 40. When the second axis arm 40 is located at the pre-set position, the first magnetic member 34 and the second magnetic member 35 are attracted to each other to lock the first axis arm 10 and the second axis arm 40.

In this way, the attraction force between the first magnetic member 34 and the second magnetic member 35 locks the first axis arm 10 and the second axis arm 40. In other words, the attraction force prevents the first axis arm 10 from rotating relative to the second axis arm 40.

The first magnetic member 34 may be fixed to the first axis arm 10 by bonding and similarly, the second magnetic member 35 may be fixed to the second axis arm 40 by bonding. Further, to make the structure of the gimbal 200 more compact, the first axis arm 10 and the second axis arm 40 may be provided with corresponding receiving slots to accommodate the first magnetic member 34 and the second magnetic member 35.

When the first magnetic member 34 and the second magnetic member 35 are mutually attracting elements, and the first axis arm 10 and the second axis arm 40 are locked, the first magnetic member 34 and the second magnetic member 35 are aligned with each other at the pre-set position. As such, the attraction force between the first magnetic member 34 and the second magnetic member 35 is maximized, thereby improving the stability of the locking of the first axis arm 10 and the second axis arm 40. The second magnetic member 35 includes an attraction surface opposite to the first magnetic member 34. The alignment of the first magnetic member 34 and the second magnetic member 35 refers to that an orthogonal projection of the first magnetic member 34 on the attraction surface falls within the attraction surface.

In some embodiments, the first magnetic member 34 and the second magnetic member 35 are both magnets to obtain a suitable attraction force between the first magnetic member 34 and the second magnetic member 35. It should be understood that, when the first magnetic member 34 is a magnet, the second magnetic member 35 may be made of a ferromagnetic material. In some embodiments, when the second magnetic member 35 is a magnet, the first magnetic member 34 may be made of a ferromagnetic material. The present disclosure does not limit the materials and structures of the first magnetic member 34 and the second magnetic member 35.

Further, when the electric motor 20 drives the rotation shaft 21 to rotate with the second driving force, that is, when the electric motor 20 drives the rotation shaft 21 to rotate with a driving force greater than the attraction force between the first magnetic member 34 and the second magnetic member 35, the attraction force is overcome, thereby achieving the unlocking.

In some embodiments, the first magnetic member 34 and the second magnetic member 35 may both be electromagnetic members. It should be understood that the electromagnetic members may generate a magnetic force after being energized.

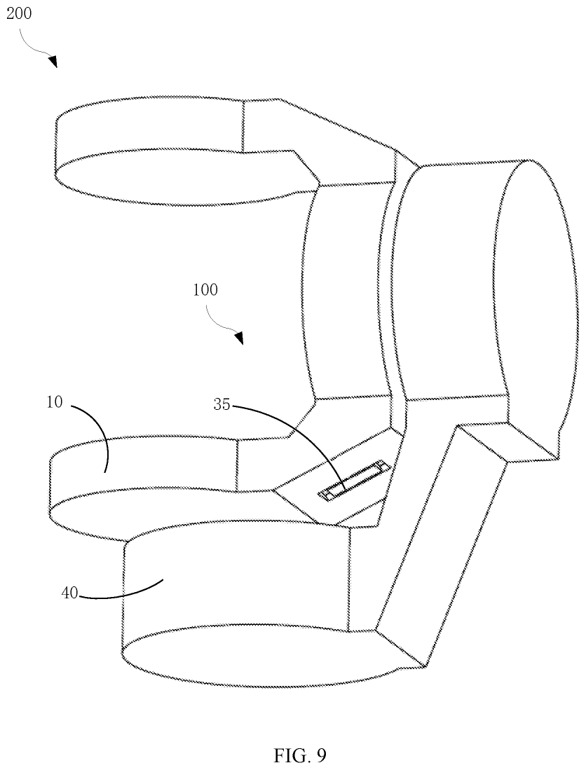

Referring to FIG. 8 and FIG. 9, in some embodiments, when the second axis arm 40 is located at the pre-set position, the first magnetic member 34 and the second magnetic member 35 repels with each other to lock the lock the first axis arm 10 and the second axis arm 40. For example, the first magnetic member 34 and the second magnetic member 35 have a same pole, thereby generating mutually repelling forces.

When the first magnetic member 34 and the second magnetic member 35 are repelling elements, and the first axis arm 10 and the second axis arm 40 are locked, the first magnetic member 34 and the second magnetic member 35 are misaligned.

It should be understood that after the repulsion force is generated by the first magnetic member 34 and the second magnetic member 35, the repulsion force may form a torque for driving the first axis arm 10 to rotate. When the first magnetic member 34 and the second magnetic member 35 are misaligned, the repulsion force drives the first axis arm 10 to rotate to a deadlock position, and turns a transmission angle of the first axis arm 10 to zero. As such, the first axis arm 10 is unable to continue to rotate, and becomes locked. The second magnetic member 35 includes a repulsion surface opposite to the first magnetic member 34. The misalignment of the first magnetic member 34 and the second magnetic member 35 refers to that an orthogonal projection of the first magnetic member 34 on the repulsion surface falls outside the repulsion surface.

Further, when the electric motor 20 drives the rotation shaft 21 to rotate with the second driving force, that is, when the electric motor 20 drives the rotation shaft 21 to rotate with a driving force greater than the repulsion force between the first magnetic member 34 and the second magnetic member 35, the repulsion force is overcome, thereby achieving the unlocking.

In some embodiments, the locking and unlocking of the lock device 30 may also be achieved by using an external force instead of the electric motor 20. For example, in one embodiment, the user may apply the first driving force at the pre-set position to lock the first axis arm 10, and/or the user may apply the second driving force at the pre-set position to unlock the first axis arm 10, which is not limited by the present disclosure.

In the description of the specification, the description with reference to terms such as “one embodiment,” “some embodiments,” “exemplary embodiments,” “examples,” “specific examples,” or “some examples” refer to that a combination of specific features, structures, materials, or characteristics described in the embodiments or examples are included in at least one embodiment or example of the present disclosure. In the specification, illustrative representations of the terms do not necessarily refer to the same embodiment or example. Moreover, the described specific features, structures, materials, or characteristics may be combined in any one or more embodiments or examples in suitable manners.

In the specification, specific examples are used to explain the principles and implementations of the present disclosure. The description of the embodiments is intended to assist comprehension of the present disclosure. Those of ordinary skill in the art may change or modify the specific implementation according to the ideas of the present disclosure. Thus, the content of the specification should not be construed as limitation to the present disclosure.

What is claimed is:

1. A gimbal comprising:
a rotation assembly including:
an axis arm;
a lock device; and
an electric motor configured to:
drive the axis arm with a first driving force to rotate to a pre-set position, such that the lock device locks the axis arm at the pre-set position; and
when the axis arm is at the pre-set position, drive the axis arm with a second driving force to rotate, such that the lock device unlocks the axis arm.

2. The gimbal according to claim 1, wherein:
output values of the first driving force and the second driving force are greater than an output value outputted by the electric motor when the gimbal is in an operation state.

3. The gimbal according to claim 2, wherein:
the first driving force and the second driving force are pre-configured to be same.

4. The gimbal according to claim 1, wherein:
the lock device includes:
an elastic member fixed to an electric motor base and including a first limiting structure disposed along an axial direction of the electric motor; and
a second limiting structure disposed at a rotation shaft of the electric motor; and
the first limiting structure and the second limiting structure are configured to snap with each other after the electric motor drives the axis arm to rotate to the pre-set position, to prevent the axis arm from further rotating.

5. The gimbal according to claim 4, wherein:
the second limiting structure is disposed at a shaft end surface of the rotation shaft of the electric motor, and the elastic member is disposed opposite to the shaft end surface; or
the first limiting structure includes a snap recess, the second limiting structure includes a snap protrusion configured to rotate with the rotation shaft of the electric motor and be coupled with the snap recess, and the elastic member is configured to, when the snap protrusion contacts the snap recess, deform in a direction facing away from the snap protrusion and then reset, such that the snap protrusion snaps into the snap recess when the axis arm is at the pre-set position.

6. The gimbal according to claim 5, wherein:
the first limiting structure has a columnar shape;
the first limiting structure includes a guide surface for guiding the snap protrusion to snap into the snap recess; or
the electric motor base includes an outer wall, the elastic member is disposed outside the outer wall, the first limiting structure passes through the outer wall in the axial direction of the electric motor and enters inside of the outer wall, and the first limiting structure is configured to move relative to the outer wall along the axial direction of the electric motor during an elastic deformation of the elastic member.

7. The gimbal according to claim 4, wherein:
the first limiting structure includes a snap protrusion;
the second limiting structure includes a snap recess configured to rotate with the rotation shaft of the electric motor and be coupled with the snap protrusion; and
the elastic member is configured to, when the snap protrusion contacts the snap recess, deform in a direction facing away from the snap protrusion and then reset, such that the snap protrusion snaps into the snap recess when the axis arm is at the pre-set position.

8. The gimbal according to claim 1, wherein:
the axis arm is a first axis arm;
the rotation assembly further includes a second axis arm rotatably connected to the first axis arm; and
the electric motor is configured to:
drive the first axis arm with the first driving force to rotate around a rotation axis relative to the second axis arm to the pre-set position, such that the lock device locks the first axis arm relative to the second axis arm; and
when the first axis arm is at the pre-set position, drive the first axis arm with the second driving force to rotate, such that the lock device unlocks the first axis arm from the second axis arm.

9. The gimbal according to claim 8, wherein:
the lock device includes a first magnetic member fixed to the first axis arm and a second magnetic member fixed to the second axis arm; and
the first magnetic member and the second magnetic member are configured to, when the first axis arm is at the pre-set position, align with and be attracted to each other to lock the first axis arm relative to the second axis arm.

10. The gimbal according to claim 8, wherein:
the lock device includes a first magnetic member fixed to the first axis arm and a second magnetic member fixed to the second axis arm; and
the first magnetic member and the second magnetic member are configured to, when the first axis arm is at the pre-set position, misalign with and be repelled from each other to lock the first axis arm relative to the second axis arm.

11. A gimbal comprising:
a rotation assembly including:
a first axis arm configured to rotate around a rotation axis;
a second axis arm rotatably connected to the first axis arm and rotatably disposed at an external device, such that the gimbal as a whole rotates relative to the external device; and
a lock device including a first element and a second element configured to be attracted to each other to lock the first axis arm relative to the second axis arm;
wherein when the first axis arm is locked, the first axis arm is fixed relative to the second axis arm.

12. The gimbal according to claim 11, wherein:
the first axis arm is mounted at the second axis arm and configured to, after rotating to a pre-set position, be locked relative to the second axis arm to prevent the rotation assembly from moving freely.

13. The gimbal according to claim 11, wherein the rotation assembly is configured to:
be locked after the first axis arm is driven by a first driving force to rotate to a pre-set position; and
be unlocked when the first axis arm at the pre-set position is driven by a second driving force, the first driving force being greater than the second driving force.

14. The gimbal according to claim 11, further comprising:
a display device disposed at a base or a handle and configured to receive a user input or display data.

15. The gimbal according to claim 11, wherein:
the rotation assembly is configured to be locked in a locked state after the first axis arm is driven to a pre-set position in response to the gimbal receiving a power off command.

16. The gimbal according to claim 11, wherein:
the rotation assembly is configured to be unlocked and be in an unlocked state after the first axis arm is driven by a driving force in response to the gimbal receiving a power on command.

17. The gimbal according to claim 11, wherein:
the rotation assembly is configured to be locked in a locked state after the first axis arm is driven by a driving force to rotate to a pre-set position; and
an output value of the driving force is greater than an output value of an operation driving force outputted by an electric motor of the rotation assembly when the gimbal is in an operation state.

18. The gimbal according to claim 11, wherein:
the lock device is configured to lock the rotation assembly after the first axis arm rotates to a pre-set position.

19. The gimbal according to claim 18, wherein:
the first element includes a first magnetic member;
the second element includes a second magnetic member; and
the first magnetic member and the second magnetic member are configured to, when the first axis arm is at the pre-set position, align with and be attracted to each other to lock the first axis arm relative to the second axis arm.

20. The gimbal according to claim 11, wherein:
the first element is fixed to the first axis arm; and
the second element is fixed to the second axis arm.
